(19) United States
(12) Patent Application Publication
(10) Pub. No.: US 2018/0353943 A1
(43) Pub. Date: Dec. 13, 2018

(54) Presulfurized Catalyst Composition

(71) Applicant: Porocel International, LLC, Reading, OH (US)

(72) Inventors: James Dallas Seamans, Houston, TX (US); Evonne Koh, Singapore (SG)

(21) Appl. No.: 15/562,352

(22) PCT Filed: Mar. 25, 2016
(86) PCT No.: PCT/US16/24257

§ 371 Date: Sep. 27, 2017

Related U.S. Application Data
(60) Provisional application No. 62/139,423, filed on Mar. 27, 2015.

(51) Int. Cl. B01J 27/051; B01J 37/20; C10G 45/08; C10G 47/06; C10G 3/00

(52) U.S. Cl. CPC B01J 27/0515; B01J 37/20; C10G 45/08; C10G 2300/202; C10G 3/50; C10G 3/46; C10G 47/06

(57) ABSTRACT

A system and method of presulfurizing a catalyst. The presulfurizing of the catalyst includes contacting the catalyst with elemental sulfur, an olefin, and a triglyceride to form a mixture, and heating the mixture to give a presulfurized catalyst.

### FIELD

The present techniques relate generally to hydroprocessing and associated presulfurized catalyst compositions. In particular, the hydroprocessing may involve hydroprocessing of cracked feedstocks, and the catalyst may be presulfurized using a combination of olefin and triglycerides.

### BACKGROUND

Hydroprocessing catalysts may include catalyst compositions for hydrotreating, hydrocracking, and so forth. A hydrotreating catalyst may be a catalyst composition employed to catalyze the hydrogenation of hydrocarbon feedstocks, and more particularly, to hydrogenate particular components of the feedstock, such as sulfur-, nitrogen- and metals-containing organo-compounds and unsaturates. A hydrocracking catalyst may be a catalyst composition employed to crack large petroleum derived molecules to attain smaller molecules with the concomitant addition of hydrogen to the molecules.

A particular application of hydrotreating catalyst may be for the hydrotreating or hydrogenation of pyrolysis gasoline or pygas. Pygas may be generally be a naphtha-range product with a high aromatics content. Pygas (e.g., C5+ cut) may be a liquid by-product derived from steam cracking of various hydrocarbon feedstocks in olefin plants. Indeed, pygas may be a by-product of high temperature naphtha cracking during ethylene and propylene production. In general, pygas may be a high-octane number mixture which contains aromatics, olefins and paraffins ranging from C5s to C12s.

Catalyst compositions for hydroprocessing, such as for hydrotreating, hydrocracking, and/or pygas treating, may have metal oxide catalysts including cobalt-molybdenum, nickel-tungsten, and nickel-molybdenum. The catalysts may also have boron in their formulation. The catalysts may be supported typically on alumina, silica and silica-alumina, including zeolite carriers, and so on. Also, transition element catalysts may be employed as hydroprocessing catalysts. In general, the hydroprocessing catalysts may have at least one element selected from V, Cr, B, Mn, Re, Co, Ni, Cu, Zn, Mo, W, Rh, Pd, Pt, Ag, Au, Cd, Sn, Sb, Bi and Te.

To promote effectiveness, the metal oxide catalysts may be converted at least in part to metal sulfides. The metal oxide catalysts can be sulfided in the hydroprocessing reactor by contact at elevated temperatures with hydrogen sulfide or a sulfur-containing oil or feedstock. However, it may be advantageous to the user to instead be supplied with metal oxide catalysts having sulfur incorporated therein. These presulfurized catalysts can be loaded into a reactor and brought up to reaction conditions in the presence of hydrogen causing the sulfur to react with hydrogen and the metal oxides, thereby converting the sulfur into sulfides without additional processing in certain examples. These presulfurized catalysts may provide an economic advantage to the plant operator and avoid problems associated with use of hydrogen sulfide, liquid sulfides, polysulfides and/or mercaptans to sulfide the catalysts.

The competitive business of hydroprocessing, such as hydrotreating (hydrogenation), hydrocracking, pygas treatment, and the associated catalyst compositions, drives manufacturers in the continuous improvement of their processes and products in order to lower production costs and deliver quality products. In these industries where very large amounts of feedstocks are processed annually, small incremental improvements in the catalyst and processing can give substantial economic benefit.

### SUMMARY

An aspect relates to method of presulfurizing a catalyst. The method includes contacting the catalyst with elemental sulfur, an olefin, and a triglyceride or triglycerides to form a mixture, and heating the mixture to give a presulfurized catalyst.

Another aspect relates to a catalyst composition. The catalyst composition includes a presulfurized catalyst formed by contacting a sulfidable catalyst with elemental sulfur, an olefin, and a triglyceride to form a mixture, and heating the mixture.

Yet another aspect relates to a method of hydroprocessing. The method includes contacting hydrogen, a presulfurized catalyst, and a hydrocarbon feed in a reactor, wherein the presulfurized catalyst is formed by heating a mixture of a sulfidable catalyst, elemental sulfur, an olefin, and a triglyceride. The method includes converting the presulfurized catalyst to a sulfided catalyst in the reactor. Further, the method includes catalyzing, via the sulfided catalyst, hydroprocessing of the hydrocarbon feed in the reactor.

### BRIEF DESCRIPTION OF THE DRAWINGS

The advantages of the present techniques are better understood by referring to the following detailed description and the attached drawings, in which:

FIG. 1 is a conceptual simplified diagram of an exemplary catalyst preparation system having at least one catalyst mix vessel to produce a presulfurized catalyst for hydroprocessing and other applications in accordance with examples of the present techniques;

FIG. 2 is a conceptual simplified diagram of an exemplary hydroprocessing system having a hydroprocessing reactor in accordance with examples of the present techniques;

FIG. 3 is a block diagram of an exemplary method of presulfurizing a catalyst in accordance with examples of the present techniques; and

FIG. 4 is block diagram of an exemplary method of hydroprocessing using a presulfurized catalyst to catalyze the hydroprocessing in accordance with examples of the present techniques.

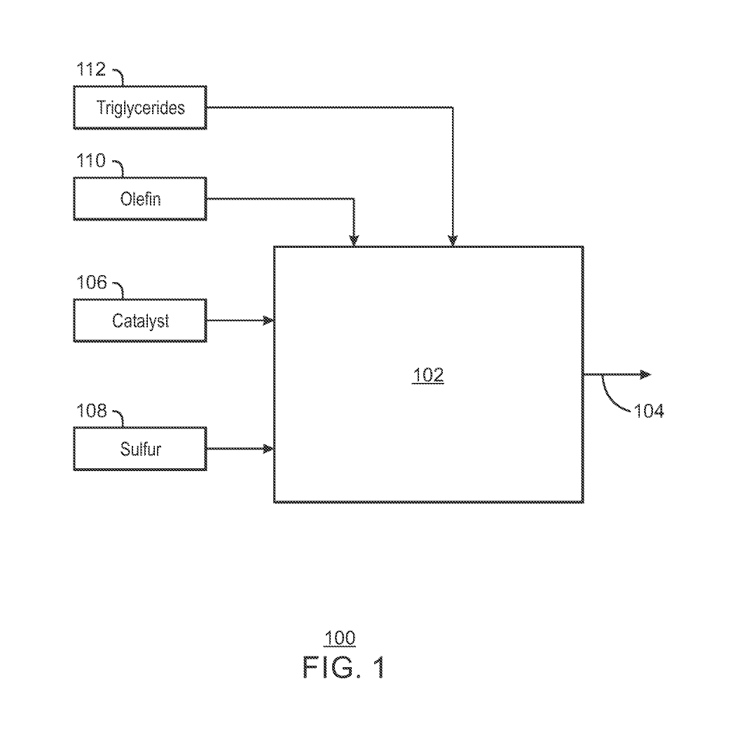

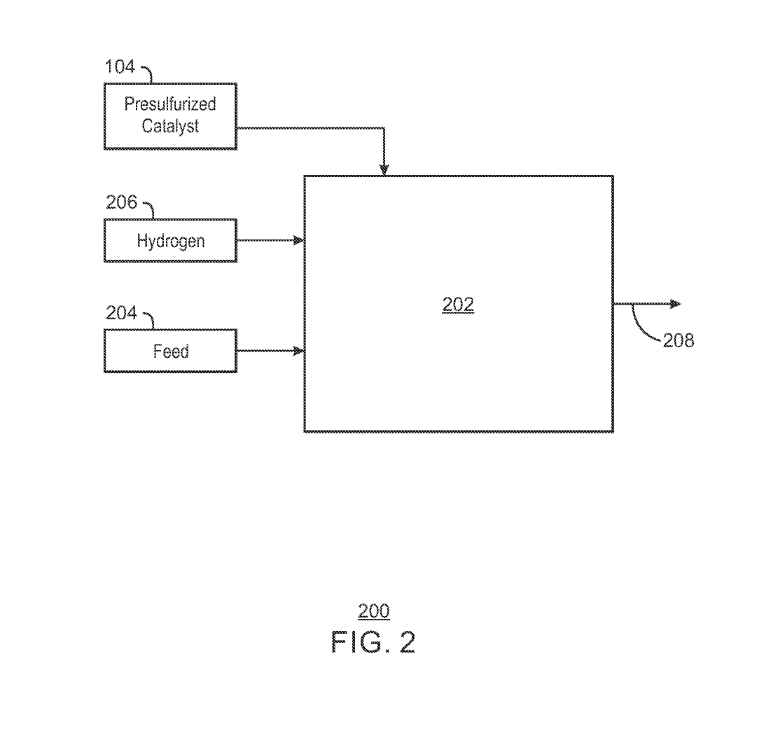

The same numbers are used throughout the disclosure and the figures to reference like components and features. Numbers in the 100 series refer to features originally found in FIG. 1; numbers in the 200 series refer to features originally found in FIG. 2; and so on.

### DETAILED DESCRIPTION

In the following detailed description section, specific examples of the present techniques are described. However, to the extent that the following description is specific to a particular example or a particular use of the present techniques, this is intended to be for exemplary purposes only and simply provides a description of the exemplary examples. Accordingly, the techniques are not limited to the specific examples described below, but rather, include all alternatives, modifications, and equivalents falling within the true spirit and scope of the appended claims.

Examples of the present techniques presulfurize metal oxide catalysts. The techniques may be directed to presulfurizing metal oxide catalysts which reduce sulfur stripping upon start-up of a hydroprocessing reactor, and increase catalyst activity. The techniques may be applicable to hydrotreating, hydrocracking, and/or pygas treating catalysts, and other catalysts. In certain examples, a metal oxide-containing catalyst is contacted with elemental sulfur at a temperature (e.g., at 80° C. or greater) such that the elemental sulfur is substantially incorporated in the pores of the catalyst by sublimation and/or melting. The resulting sulfur-incorporated catalyst may be heated in the presence of an olefin, e.g., liquid olefin, and a triglyceride, at a temperature greater than about 150° C. (or greater than about 180° C., 200° C., 220° C., 230° C., 250° C. etc.) to give the presulfurized catalyst. In one example, the temperature is in the range of 250° C. to 350° C. In another example, the temperature is in the range of 180° C. to 350° C. In yet another examples, the temperature is in the range of 250° C. to 400° C., or 180° C. to 400° C.

Certain embodiments through the mixing and heating of the sulfidable catalyst, olefin, triglyceride form a beneficial carbonaceous structure (e.g., shield, barrier, shell, etc.) on and within the presulfurized catalyst. The carbonaceous barrier may contained the elements carbon, hydrogen, sulfur, and optionally the elements oxygen and/or nitrogen. The carbonaceous barrier may be created when the elemental S reacts with the olefinic bonds in the mixture of liquid olefins and triglycerides (e.g., vegetable oils) thereby creating sulfur cross links between the hydrocarbon structures of the olefins and triglycerides. In some embodiments, a majority of the barrier is within the catalyst pores. Thus, the barrier may be more of a shield within the catalyst particle than a shell disposed on the outside of the catalyst particles.

The carbonaceous structure or barrier may be formed external on the presulfurized catalyst and/or within catalyst pores of the presulfurized catalyst. Such may address the refining unit processing of some percentage of cracked feedstocks (e.g. coker naptha, coker diesel, light cycle oil, etc.) along with straight run feeds (e.g., direct cuts off the distillation units). Fresh catalyst manufacturers have advised refiners for decades to process straight run feeds on fresh catalyst for at least the first three days. That is because cracked feeds, such as coker naphtha and light cycle oil (LCO), are known to be higher in coke precursors such as diolefins and aromatics. Exposure of fresh catalyst to these coke precursors can impair the performance of the catalyst from the beginning of the cycle. However, it can be difficult logistics and/or costly for the refiners to store the cracked feed for those extra days while running on straight run feed.

Thus, embodiments disclosed herein may provide additional protection (including for fresh, regenerated, rejuvenated, revitalized, or other reusable catalyst) with the forming of a beneficial carbonaceous barrier on the presulfurized catalyst by combining the olefin and triglyceride(s) in the presulfurization technique. This carbonaceous shield formed via catalyst pretreatment technology disclosed herein that presulfurizes the catalyst may protect the catalyst, for example, from the damaging effects of diolefins and aromatics found in cracked feeds. In certain examples, the catalyst hyperactivity may be moderated to protect against rapid deactivation caused by the early introduction of certain components such as coker or light cycle oil (LCO) components. Consequently, in general, toxic sulfiding agents, temperature holds, dry-out steps, and delay in introducing cracked feeds may be avoided in certain embodiments. In examples, sulfidable hyrdoprocessing catalysts treated via the presufurization techniques disclosed herein may provide presuflurized catalyst that may be started in the hydroprocessing reactor without a break-in period and give equivalent or better activity than catalysts sulfided in-situ with three-day straight run conditioning.

In examples, the presulfurization techniques herein may be characterized as cracked feed protection in that the particular presulfurization via the combination of olefin and triglyceride, along with the specified mixing and heating, may subsequently protect the catalyst from deactivation in the hydroprocessing reactor associated with early introduction of cracked feeds into the hydroprocessing reactor. This may facilitate the acceptable early introduction of cracked feed to the hydroprocessing reactor, including upon startup of the hydroprocessing reactor or substantially immediately thereafter. The early introduction of cracked feed to the reactor can be beneficial, for instance, for facilities having limited storage for cracked feeds. Again, in certain examples, the present presulfurized catalysts with the startup of cracked feed can give equivalent or better activity than in-situ sulfided catalyst having a typical 3-day break-in period on 100% straight run gas oil (SRGO).

A benefit may be speed in the sense of starting up on cracked feed (LCO/Coker). A benefit may be performance in that each catalyst pellet may be treated with sulfur in presence of combined olefin and triglyceride that gives high activity and reduced potential for metals reduction. A benefit may be convenience in that the use of Draeger Tubes or sulfiding agents may not be required at the hydroprocessing reactor.

The sulfiding catalysts may provide for substantially full sulfiding (>80% to the metal sulfides) by adding, for example, hydrogen (H2) to the heat treatment step prior to supplying the “presulfided” catalyst to the refiner. Indeed, techniques may optionally add H2 to the presulfurized catalyst ex-situ of the reactor. The H2 addition ex-situ may be for various forms of actiCAT (not just the shield or barrier version, for instance).

As used herein, the phrase “metal oxide catalyst” refers to a “metal oxide-containing catalyst” or a catalyst containing one or more metal oxides. Such catalysts may include cobalt-molybdenum, nickel-tungsten, nickel-molybdenum, or other metals and oxides of those metals. The catalysts may be employed in catalyst compositions for hydroprocessing including hydrotreating, hydrocracking, and/or pygas treating, may have metal oxide catalysts including. The catalysts may be supported typically on alumina, silica and silica-alumina, including zeolite carriers, and so on. Also, transition element catalysts may be employed as hydroprocessing catalysts. In general, the “metal oxide catalyst” including as hydroprocessing catalysts may have at least one element selected from V, Cr, Mn, Re, Co, Ni, Cu, Zn, Mo, W, Rh, Pd, Pt, Ag, Au, Cd, Sn, Sb, Bi and Te.

The term “olefin” as used herein refers to hydrocarbon molecules containing at least one carbon-carbon double bond and may typically include hydrocarbons containing at least one carbon-carbon double bond in addition to other functional moieties, such as carboxylate, halo, etc., provided such additional moieties do not adversely react with the catalytic metals on the catalyst. The olefins may be monoolefins or polyolefins, cyclic or acyclic, linear or branched. Non-limiting examples of monoolefins include decone, undecene, dodecene, tridecene, tetradecene, pentadecene, hexadecene, heptadecene, octadecene, nonadecene, eicosene, and the like, whether branched, linear or cyclic, alpha or internal olefin. Similar materials in the form of di-, tri- and polyolefins may be used. Polycyclic olefins and polyolefins may also be used. Typical olefins may be alpha linear olefins in the C18 to C26 range, although branched isomers and internal olefins in this same range are also typically applicable.

As used herein, a triglyceride is an ester formed from glycerol and three fatty acid chains. Examples of triglycerides that can be used in the techniques described herein include soybean oil, linseed oil, canola oil, and any number of other triglycerides. The amount of unsaturation along the fatty acid chains may have some effect on the process, but the primary factor in choosing a particular triglyceride is economic. In any process described herein that refers to a specific triglyceride, such as soybean oil, it may be understood that any number of other triglycerides may be used instead of, or in combination, with the specific triglyceride mentioned.

Thus, examples herein presulfurize a hydrotreating, hydrocracking, and/or or pygas treating catalyst in a manner which reduces sulfur stripping upon start-up of a hydrotreating, hydrocracking, and/or pygas treating reactor. The catalyst may be fresh or regenerated. The techniques may provide a presulfurized hydrotreating, hydrocracking, and/or pygas catalyst that upon activation in-situ provide an active hydrotreating, hydrocracking, and/or pygas catalyst. Moreover, examples may give a presulfurized hydrotreating, hydrocracking, and/or pygas catalyst that can provide for a relatively rapid startup of the hydroprocessing reactor.

To presulfurize the catalyst, e.g., a sulfidable catalyst, the catalyst may be first contacted with the elemental sulfur, and the sulfur-impregnated (or sulfur-incorporated) catalyst subsequently contacted with the olefin and triglyceride. On the other hand, the catalyst may be contacted with the elemental sulfur, olefin, and triglyceride at the same initial time or substantially the same initial time to give the presulfurized catalyst. For instance, a sulfidable metal oxide catalyst may be contacted with a mixture of powdered elemental sulfur, liquid olefinic hydrocarbon, and a triglyceride, such as soybean oil. The resultant mixture is heated to a temperature above about 150° C., or above about 180° C. Of course, a variety of addition sequences and temperatures may be employed in other examples of the present techniques. In general, the catalyst may incorporate sulfur in the catalyst pores giving a sulfur-incorporated or sulfur-impregnated catalyst, and this sulfur-incorporated catalyst contacting the olefin and triglyceride to become a presulfurized catalyst.

In sum, to presulfurize the catalyst, the porous catalyst particles may be contacted with elemental sulfur under conditions which cause the sulfur to be incorporated into the pores of the catalyst by sublimation or melting, or by a combination of both sublimation and melting. The sulfur-incorporated catalyst particles may be contacted with an olefin and the triglyceride at elevated temperatures and times to cause the sulfur-incorporated catalyst particles to have enhanced resistance to sulfur stripping during the subsequent startup in a hydrotreating, hydrocracking, and/or pygas processing reactor in the presence of a hydrocarbon feedstock. As indicated, in particular examples, when such presulfurized catalysts are used for hydroprocessing such as pygas treating, the reactor may be started up more rapidly than with catalysts presulfurized without olefin and triglycerides. Moreover, while the present discussion may focus at times on use of elemental sulfur S for catalyst sulfiding, embodiments are also applicable using a variety of sulfur compounds, such as DMS, DMDS, TNPS, Sulfrzol 54, mercaptans, and other sulfur compounds, in the catalyst-sulfidng formulation.

The mechanism by which the heating of the sulfur-incorporated catalyst at elevated temperatures in the presence of the olefin and the triglyceride such that the catalyst becomes more resistant to sulfur stripping may be referenced herein as “reaction” or “reacts” for lack of better terminology. Yet, a result of this mechanism can generally readily be determined by measuring the resistance to sulfur stripping of catalysts, and the activity of the catalysts. The presulfurized catalysts in examples of the present techniques may typically have enhanced resistance to sulfur stripping. One exemplary method for determining sulfur stripping resistance may employ toluene or acetone as a stripping agent.

Furthermore, the catalysts referred to herein as “sulfidable metal oxide catalysts” can in fact be catalyst precursors, that is, they are used as actual catalysts while in the sulfided form and not in the oxide form. While reference is made to metal oxide catalysts, and while conventional catalyst preparative techniques may produce metal oxide, it is possible to utilize preparative techniques to produce the catalytic metals in a reduced form, such as the zero valent state. Further, because metals in the zero valent state may be sulfided as well as the oxides when subjected to sulfiding conditions, catalysts containing such sulfidable metals even in reduced or zero valent states may be considered as sulfidable metal oxide catalysts. Additionally, because the preparative techniques herein may be applied to regenerated catalysts which may have the metal sulfide not completely converted to the oxides, “sulfidable metal oxide catalysts” may also refer to these catalysts which have part of their metals in the sulfided state.

There are various examples herein to presulfurize the catalyst. For instance, a porous sulfidable metal oxide catalyst may be contacted with elemental sulfur (e.g., powdered form, molten state, etc.) at a temperature such that the elemental sulfur is substantially incorporated in the pores of the catalyst by sublimation and/or melting, or other transfer. The elemental sulfur may be mixed with the catalyst particles, and the mixture heated to above the temperature at which sublimation of the sulfur occurs. Further, this sulfur-incorporated catalyst may be heated in the presence of an olefin, e.g., liquid olefinic hydrocarbon, and a triglyceride at a temperature greater than about 150° C., or above about 180° C., to give a presulfurized catalyst. In particular instances, the heating rate may be sufficiently slow such that the sulfur is incorporated into the pores of the catalyst by sublimation and/or melting prior to reaching the temperature at which the olefin and triglyceride reacts with the catalyst to make the sulfur on the catalyst more resistant to stripping.

Generally, in some examples, the catalyst particles are heated in the presence of the powdered elemental sulfur at a temperature greater than about 80° C. In certain examples, this initial sulfur impregnation may be carried out at a temperature ranging from about 90° C. to about 130° C. or higher, such as up to the boiling point of sulfur of about 445° C. In some examples, the lower-end values of the temperature range may be determined by, and specified based on, the sublimation/melting characteristics of sulfur under the specific conditions of the sulfur-incorporation or impregnation, and other factors. The upper-end values of the temperature range may be determined by, and specified based on, economics and other considerations. Implementing higher temperatures may be more costly and problematic. In a particular example, the catalyst and sulfur are heated together at a temperature ranging from about 105° C. to about 125° C.

In certain examples, the catalyst and powdered sulfur are placed in a mixer, such as a vibratory or rotary mixer, and heated to the desired temperature for a specified time (e.g., 0.1 hour to about 10 hours or longer) to facilitate the sulfur to be incorporated into the pores of the catalyst. The amounts of sulfur added may depend upon the amounts of catalytic metal present in the catalyst to be converted to the sulfide. Typically, the amount of sulfur used may be determined and specified based on the stoichiometric amount of sulfur to convert most or all of the metal on the catalyst to the sulfide form. For example, in examples, a catalyst containing molybdenum would receive about two moles of sulfur to convert each mole of molybdenum to molybdenum disulfide, with similar determinations being made for other metals. On regenerated catalysts, existing sulfur levels may be factored into the calculations for the amounts of elemental sulfur added.

The addition of presulfurizing sulfur in amounts down to about 50 percent of the stoichiometric requirement may give catalysts having enhanced hydrodenitrification activity, which may be an important property, for example, of hydrotreating and first-stage hydrocracking catalysts. Thus, the amount of presulfurizing elemental sulfur used for incorporation into the catalyst may typically range from about 0.5 to about 1.5 times the stoichiometric amount, or from about 0.7 to about 1.2 times the stoichiometric amount, and the like. For pygas catalyst, a target may typically be less than the stoichiometric amount, to allow the metals to be partially reduced. For pygas catalyst, an exemplary range may be 0.05 stoichiometric amount to 1.0 stoichiometric amount.

For hydrotreating/hydrocracking and pygas treating catalysts containing Group VIB and/or Group VIII metals, the amount of sulfur employed may typically be about 2% to about 15% by weight of the catalyst charged. In other examples, the amount of sulfur employed may be about 6% to about 12% by weight of the catalyst charged. The specified amount of sulfur added may be such that the catalyst pores are not completely filled. By leaving residual pore volume, the olefin and triglyceride can penetrate the pores and react therein.

As discussed, the sulfur-impregnated metal catalyst is contacted with an olefin and a triglyceride at an elevated temperature and specified time at temperature such that contact of the olefin and triglyceride with the sulfur-impregnated metal catalyst provides a sulfurized or presulfurized catalyst that is more resistant to sulfur leaching. Typically, the contact temperature is greater than about 150° C., such as in exemplary ranges of about 150° C. to about 350° C., or of about 180° C. to about 400° C., or of about 200° C. to about 325° C., and so forth. Contact times may depend on temperature and the vapor pressure of the olefin. Higher temperatures and higher vapor pressures may generally accommodate shorter times. In general, the time of contact of the olefin and the triglyceride with the catalyst at elevated temperature may range from about 0.1 hour to about 10 hours. The heating of the mixture may be in a substantially inert environment, such as with maintained with nitrogen.

In examples, it may be beneficial for the olefin to be a liquid at the elevated temperature of contact. Thus, the olefin may be a higher olefin, e.g., having a carbon number greater than six, or greater than eight, and so forth. In some examples, the upper carbon number of applicable olefins may be determined by the melting point of the olefin in question. While waxy olefinic materials having carbon numbers around 60, for instance, can be used in certain examples. However, these heavier olefins may need to be subjected to a solvent, or heated to a relatively high temperature, to change the waxes into a liquid. Thus, in some examples, olefins with carbon numbers ranging from about 6 to about 30, or about 8 to about 25, and the like, may be employed.

The olefins may also be admixed with non-olefinic hydrocarbons, such as alkanes or aromatic solvents. In general, the olefin content of an olefin-containing hydrocarbon used in examples may be above about 5% wt., above about 10% wt., or above about 30% wt. Generally, higher olefin contents are used, say, above about 50% wt., and the olefin may be used in the undiluted form. The term “olefinic hydrocarbon” as used herein refers to a hydrocarbon that contains olefinic molecules with or without the presence of non-olefinic molecules. It is understood that the olefins may be provided as olefin precursors which are converted to olefins before or upon reaching the reaction temperature.

The lower amounts of olefins used may be specified for reaction at elevated temperature that gives reduced sulfur leaching of the catalyst. The larger amounts of olefin used may be determined or specified based on, for example, economics. In certain examples, the amount of olefin or olefinic hydrocarbon employed is the amount of olefinic hydrocarbon that will fill the pore volume of the sulfur impregnated catalyst or just slightly less, down to about 60 percent of the pore volume, or down to about 80 percent of the pore volume, or other percentages. A particular exemplary target range is from about 80 to about 95 percent of the pore volume is filled with the olefin. In this manner, the treated catalyst may be “dry” and more convenient to handle.

In some examples, the catalyst particles are contacted with the elemental sulfur (e.g., powdered), the olefinic hydrocarbon, and the triglyceride simultaneously or substantially simultaneously. According to such examples, a mixture of powdered elemental sulfur and olefinic hydrocarbon, with or without the triglyceride, may be first produced. A ratio of olefin to sulfur by weight may range from about 1:1 to about 4:1, or other ranges. An exemplary ratio value of olefin to sulfur is about 2:1. The mixture may be heated to promote homogenous mixing of the components, particularly if the olefinic hydrocarbon is not liquid at ambient conditions. Toluene or other light weight hydrocarbon solvents may be added to decrease the viscosity of the mixture. Also, increased heat may achieve the same effect. The olefin and solvents, along with triglyceride, may be added, for example, to a preweighed amount of catalyst and mixed. The resultant mixture may be heated to the reaction temperature of above about 150° C., or above about 180° C., for reaction of the olefin and triglyceride with the sulfur on the catalyst, in some examples. The temperature may range about 150° C. to about 350° C., or about 200° C. to about 325° C., or about 180° C. to about 400° C., or other temperature ranges. The contact times at temperature may be, for example, about 0.1 to about 10 hours. Such a contract time range may be the same or similar as in various examples that may first contact the catalyst and with the sulfur, and then contact the sulfur-incorporated catalyst with the olefin and triglyceride at about 0.1 to about 10 hours at the elevated temperature. During the heating process the sulfur generally initially impregnates the pores of the catalyst, while the olefin and triglyceride reactor with the sulfur and catalyst to for a presulfurized catalyst as a leaching resistant catalyst.

The presulfurized catalysts may be converted to sulfided catalysts by contact with hydrogen at temperatures greater than about 200° C., or from about 200° C. to about 425° C. The time at temperature can run, for example, from about 0.5 hours to up to 3 days. In operation, the presulfurized catalyst may be loaded into a hydrotreating reactor, hydrocracking reactor, and/or pygas reactor, and hydrogen flow is started to the reactor, and the reactor is heated to operating (hydrotreating, hydrocracking, or pygas treating) conditions. In the presence of hydrogen, activation of the catalyst takes place. That is, the metal oxides and hydrogen react with most or substantially all of the sulfur incorporated into the catalyst pores, thus producing hydrogen sulfide, water, and metal sulfides. In the hydrotreating and/or hydrocracking process, a hydrocarbon feedstock flow may be started simultaneously with the hydrogen or later.

The present techniques may be further applicable to the sulfurizing of spent catalysts which have been oxygen regenerated (oxy-regenerated). After a conventional oxy-regeneration process, an oxy-regenerated catalyst may be presulfurized as would fresh catalyst as set forth above. The techniques may also encompass stabilizing (including enhancing the resistance to sulfur leaching) a supported metal catalyst containing elemental sulfur, particularly a Group VIB and/or Group VIII metal catalyst, by contacting the catalyst with an olefinic hydrocarbon and triglyceride at a temperature greater than about 150° C., or greater than about 180° C.

The presulfurizing techniques herein may be applicable to hydrotreating catalysts, hydrocracking catalysts, and/or pygas treating catalysts. These catalysts typically include Group VIB and/or Group VIII metals supported on porous supports such as alumina, silica, silica-alumina, zeolite and the like. The hydrotreating catalysts, hydrocracking catalysts, and/or pygas treating catalysts may contain a group VIB metal selected from molybdenum, tungsten and mixtures thereof and a Group VIII metal selected from nickel, cobalt and mixtures thereof supported on alumina. Versatile hydrotreating and/or hydrocracking catalysts which show good activity under various reactor conditions may be alumina-supported nickel-molybdenum and cobalt-molybdenum catalysts. Phosphorous may sometimes be added as a promoter. For example, one treating catalyst which may have good activity under various reactor conditions is an alumina-supported cobalt-molybdenum catalyst.

Hydrotreating catalysts which are specifically designed for hydrodenitrification operations, such as alumina-supported nickel-molybdenum catalysts, presulfurized as described herein have higher initial activities, particularly hydrodenitrification activities, than catalysts conventionally sulfided. This higher initial activity, coupled with ability to avoid sulfiding in the presence of hydrogen sulfide, may provide the instant presulfurized catalysts with a significant commercial advantage. Such may provide for the hydrotreating and/or hydrocracking reactor to get into full operation quicker, and, once at operating conditions, have a higher activity, facilitating the reactor to be operated at either lower temperature or higher conversion. In some examples, pygas treating reactors can also be started up more quickly.

Thus, examples may relate to an improved process for starting up a hydrotreating or hydrocracking reactor, which includes loading the catalyst presulfurized as described herein, into the reactor and heating the reactor to operating conditions in the presence of hydrogen and optionally a hydrocarbon feedstock. Examples may also include an improved hydrotreating and/or hydrocracking process which involves contacting at hydrotreating or hydrocracking conditions a hydrocarbon feedstock and hydrogen with a catalyst which has been presulfurized according to present examples, and which is heated to hydrotreating and/or hydrocracking temperature in the presence of hydrogen and optionally a hydrocarbon feedstock.

Examples may provide a catalyst composition having a presulfurized catalyst formed by contacting a sulfidable catalyst with elemental sulfur, an olefin, and a triglyceride to form a mixture, and heating the mixture. The sulfidable catalyst and the presulfurized catalyst may be metal oxide catalysts having one or more oxides of metals from Group VIB and Group VII of the Periodic Table of Elements. The olefin may be olefins having carbon numbers in the range of 6 to 60. The heating may include heating the mixture to at least 150° C., or at least 180° C. In some examples, the heating may involve maintaining the mixture at a temperature of at least 150° C. (or at least 180° C.) for a time in the range of about 0.1 hour to 10 hours. Further, in certain examples, the contacting includes contacting the sulfidable catalyst with the elemental sulfur to give an initial mixture having a sulfur-incorporated catalyst, and contacting the initial mixture having the sulfur-incorporated catalyst with the olefin and triglyceride to form the mixture. The heating may include heating the initial mixture and heating the mixture.

FIG. 1 is a conceptual simplified diagram of a catalyst preparation system 100 having at least one catalyst mix vessel 102 to produce a presulfurized catalyst 104 for hydroprocessing and other applications. The catalyst preparation system 100 may have multiple mix vessels 102 which can be arranged operationally in series and/or parallel. In general for clarity, various systems, equipment, and components of the catalyst preparation system 100 are not depicted.

In the illustrated example, the catalyst mix vessel 102 is configured to receive a catalyst 106, such as a sulfidable metal oxide catalyst, and also to receive sulfur 108, such as elemental sulfur in powder or molten form. The catalyst preparation system 100 may be further configured to add olefin 110, such as liquid olefin, and a triglyceride 112 to the catalyst mix vessel 102. While the streams 106, 108, 110, and 112 are depicted as four independent streams, the streams may be added together in different combinations. For instance, in a particular example, the catalyst 106 and sulfur 108 are added together in a single stream to the mix vessel 102, and the olefin 110 and triglyceride 112 are added as separate streams or added together in a single stream to the mix vessel 102. Of course, other combinations and sequences of the addition of the streams to the vessel 102 may be implemented. Furthermore, the catalyst preparation system 100 including the catalyst mix vessel 102 may have a heat transfer system (not shown) and associated instrumentation and controls to heat and maintain the contents or mixture in the mix vessel 102 to a set-point temperature.

In operation, the catalyst 106, sulfur 108, olefin 110, and triglyceride 112 may be added to the mix vessel 102 at the same time or respective different times. As indicated, the sequence and timing of the additions may be altered. The resultant mixture in the mix vessel 102 may be heated to a specified temperature to presulfurize the catalyst 106 to give a presulfurized catalyst 104. The presence of the olefin and triglyceride may increase the catalyst activity and the sulfur stripping resistance of the presulfurized catalyst 104. In certain examples, a mixture of the catalyst 106 and sulfur 108 may be initially heated, and then a mixture of the catalyst 106, sulfur 108, olefin 110, and triglyceride 112 subsequently heated to give the presulfurized catalyst 104. The relative amounts and sequencing of the streams additions, and the heating and temperatures, may in accordance with foregoing discussion with presulfurizing a sulfidable metal oxide catalyst.

In the illustrated example of FIG. 1, a presulfurized catalyst 104 is discharged from the catalyst mix vessel 102 and may be collected for distribution to a hydroprocessing reactor (see FIG. 2) or other users. The presulfurized catalyst 104 may be subjected to additional processing prior to being collected for distribution. Further, in alternate examples, the system 100 may be configured to provide the presulfurized catalyst more directly to a hydroprocessing reactor or to a feed system of a hydroprocessing reactor. Moreover, the catalyst preparation system 100 may generally be a batch system but could also be continuous or semi-batch.

Lastly, in one example, the mix vessel 102 is two vessels in series. The first vessel may be used to contact the catalyst 106 and the sulfur to give a sulfur-incorporated catalyst. The second vessel may receive the sulfur-incorporated catalyst, the olefin 108, and the triglyceride 112, and discharge the presulfurized catalyst 104. Heating may be applied to both the first vessel and the second vessel. One or both of the vessels may be maintained with an inert or substantially inert environment, such as with a nitrogen blanket or nitrogen pad, and the like.

FIG. 2 is a conceptual simplified diagram of an exemplary hydroprocessing system 200 having a hydroprocessing reactor 202. The hydroprocessing reactor 202 may be one or more reactors, arranged operationally in series and/or parallel. Moreover, as can be appreciated, the reactor 202 generally has associated systems and equipment not depicted in the conceptual simplified diagram of FIG. 2. The reactor 202 is a reactor for hydroprocessing such as hydrotreating (hydrogenation), hydrocracking, or pygas treating, or any combination thereof.

In the illustrated example, the hydroprocessing reactor 202 is configured to receive a feed 204, such as a hydrocarbon feed, to be subjected to hydroprocessing in the reactor 202. For the reactor 202 as a hydrotreater or hydrocracker, the feed 204 may be a hydrocarbon feedstock having various hydrocarbons. For the reactor 202 as a pygas processor or pygas treater, the feed 204 may be pygas.

The hydroprocessing system 200 is configured to add hydrogen 206 and a presulfurized catalyst 104 (see, e.g., FIG. 1) to the reactor 202. The presulfurized catalyst 104 may be pre-loaded into the reactor 202, such as in a fixed bed, prior to introduction of the hydrocarbon feed 404 and hydrogen 206 to the reactor. In operation, the presulfurized catalyst 104 may be converted to a sulfide catalyst in the reactor 202. The hydroprocessing of the feed 204 in the reactor 202 may be catalyzed via the presulfurized catalyst 104 including the associated sulfided catalyst. The reactor 202 is configured to discharge a hydroprocessing reactor product 208 which may be subjected to additional processing.

Hydrotreating conditions may include temperatures ranging from about 100° C. to about 425° C., pressures above about 40 atmospheres. The total pressure may typically range from about 400 to about 2500 psig. The hydrogen partial pressure may typically range from about 200 to about 2200 psig. The hydrogen feed rate may typically range from about 200 to about 10,000 standard cubic feet per barrel (“SCF/BBL”). The feedstock rate of the hydrocarbon feed 204 may typically have a liquid hourly space velocity (“LHSV”) ranging from 0.1 to about 15.

Hydrocracking conditions may include temperatures ranging from about 300° C. to about 500° C., pressures above about 40 atmospheres. The total pressure may typically range from about 400 to about 3000 psig. The hydrogen partial pressure will may typically range from about 300 to about 2600 psig. The hydrogen feed rate may typically range from about 1000 to about 10,000 standard cubic feet per barrel (“SCF/BBL”). The feedstock rate of the hydrocarbon feed 204 may typically have a liquid hourly space velocity (“LHSV”) ranging from 0.1 to about 15. First stage hydrocrackers, which may carry out considerable hydrotreating of the feedstock may operate at higher temperatures than hydrotreaters and at lower temperatures than second stage hydrocrackers.

For hydrotreating or hydrogenation of pyrolysis gasoline (pygas), the di-olefins, olefins, and styrene in the raw or partially-processed pygas feed may be saturated. Further, in the hydroprocessing in the reactor may de-sulfurize the pygas in hydrogenating sulfur to hydrogen sulfide (H2S). In some applications, a first stage hydrotreating section may saturate primarily di-olefins to olefins. A second stage hydrotreating section may saturate the olefins and de-sulfurize the pygas. The reactions may be carried out primarily in the liquid phase on catalyst in a fixed bed reactor. The reactions may be made on a series of specific catalysts in fixed bed reactors. The operating conditions may be selected to reduce aromatics losses by hydrogenation and to reduce the formation of heavy products by polymerization. In general, the treatment may provide for hydrogenating of diolefins and olefins, and and hydrodesulfurization.

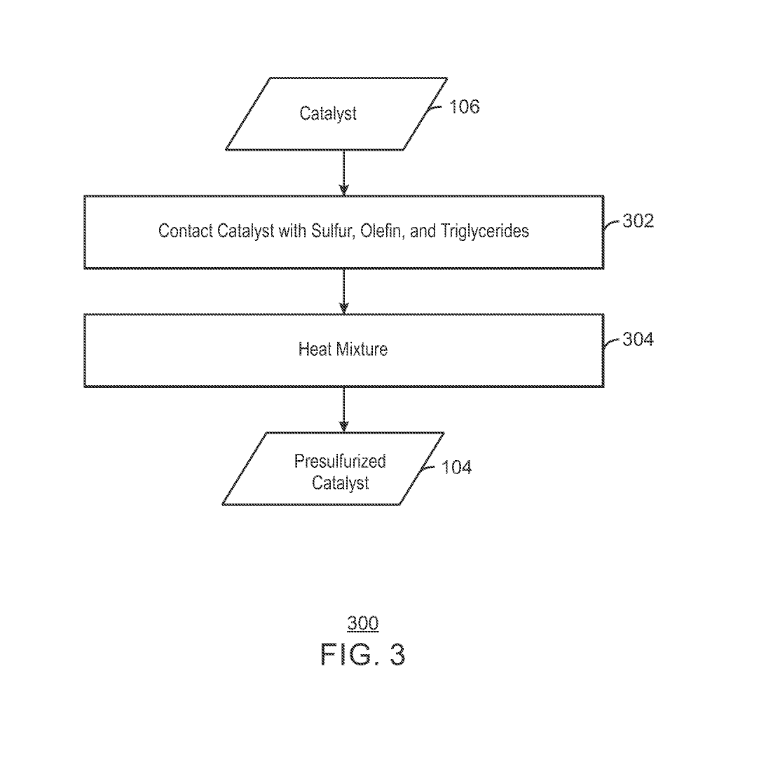

FIG. 3 is an exemplary method 300 of presulfurizing a catalyst 106. The catalyst 106 may be a sulfidable metal oxide catalyst, as discussed above. The sulfidable catalyst 106 and the subsequent presulfurized catalyst 104 may be metal oxide catalysts having one or more oxides of metals from Group VIB and Group VII of the Periodic Table of Elements. The catalyst 106 is contacted (block 302) with elemental sulfur, olefin, and triglyceride (e.g., to form a mixture). The mixture is heated (block 304) to give a presulfurized catalyst 104. The olefin may be olefins having, for example, carbon numbers in the range of 6 to 60, or 6 to 30. The heating (block 304) may be to heat the mixture to at least 150° C., or to at least 180° C., and may be performed under an inert or substantially inert environment. In examples, the heating includes maintaining the mixture at a temperature of at least 150° C. (or at least 180° C.) for a time in the range of about 0.1 hour to 10 hours.

In some examples, the contacting (block 302) includes contacting the catalyst with the elemental sulfur to give a sulfur-incorporated catalyst, and contacting the sulfur-incorporated catalyst with the olefin and triglyceride. The heating (block 304) may include heating the contacting of the catalyst with sulfur to give the sulfur-incorporated catalyst, and heating the contacting of the sulfur-incorporated catalyst with the olefin and soybean to give the presulfurized catalyst. In other words, the contacting (block 302) may involve contacting the catalyst 106 with the elemental sulfur to give an initial mixture having a sulfur-incorporated catalyst, and contacting the initial mixture having the sulfur-incorporated catalyst with the olefin and triglyceride to form the mixture. The heating (block 304) may include heating the initial mixture and heating the mixture.

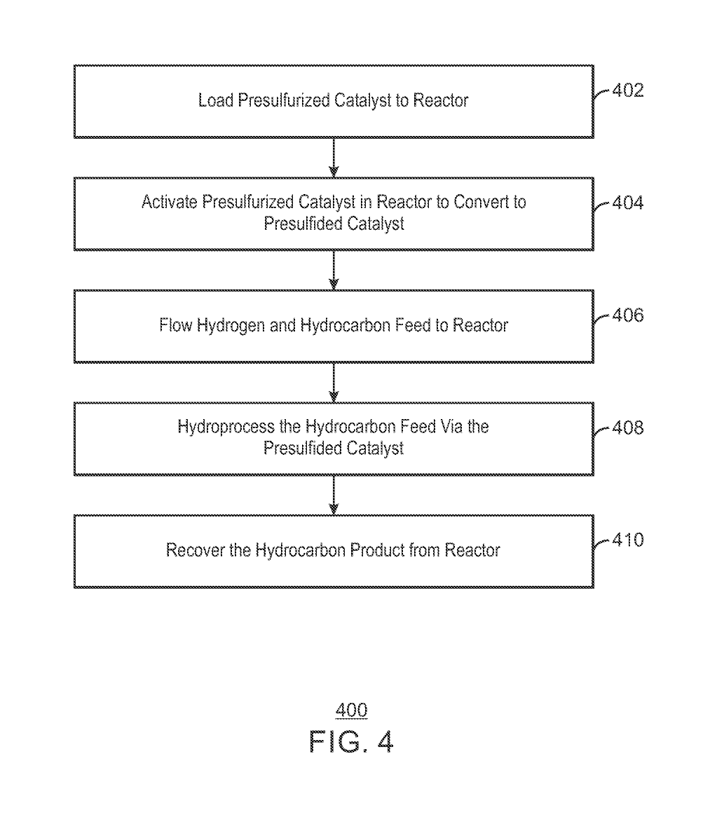

FIG. 4 is an exemplary method 400 of hydroprocessing, such as hydrotreating (hydrogenation), hydrocracking, pygas treating, and so forth, using a presulfurized catalyst to catalyze the hydroprocessing. In method 400, a presulfurized catalyst is loaded (block 402) in the reactor, such as into a fixed catalyst bed or other bed of the reactor. The reactor may then be closed and placed under inert conditions. The presulfurized catalyst may be activated (block 404) in the reactor such as with the introduction of hydrogen and optionally hydrocarbon feedstock to the reactor. The presulfurized catalyst may be activated to convert the presulfurized catalyst to a presulfided or sulfided catalyst.

To begin the primary hydroprocessing, the hydrocarbon feed and hydrogen may be fed (block 406) to the reactor across the presulfided catalyst in the reactor. The hydrorocessing of the hydrocarbon feed, including catalyzing of the hydroprocessing, is via (block 408) the presulfurized or presulfided catalyst. In the continuous processing, a hydroprocessed hydrocarbon product is discharged and recovered (block 410) from the reactor. The hydrocarbon product may be subjected to additional processing.

The continuous hydroprocessing, such as with continuous hydrotreating or pygas treating, can run for a cycle of 6 months up to 6 years or more, for example. Once the catalyst is deactivated, the catalyst may be replaced or rejuvenated for another cycle. In some embodiments, the hydrocarbon feedstock may be spiked with a sulfiding compound. The hydroprocessing reactor is typically a continuous reactor but could be batch reactor. Refineries generally operate their hysdroprocessing reactors in a continuous mode. The catalyst stays substantially fixed in the reactor and the hydrogen and hydrocarbon feed oil flow through the reactor, typically downflow, and the products are separated as they exit.

In sum, the method 400 of hydroprocessing may include contacting hydrogen, a presulfurized catalyst, and a hydrocarbon feed in a reactor, wherein the presulfurized catalyst is previously formed by heating a mixture of a sulfidable catalyst, elemental sulfur, an olefin, and a triglyceride. The method 400 may include converting the presulfurized catalyst to a sulfided catalyst in the reactor, and catalyzing via the sulfided catalyst the hydroprocessing of the hydrocarbon feed in the reactor. The presulfurized catalyst may be a metal oxide catalyst having one or more oxides of metals from Group VIB and Group VII of the Periodic Table of Elements. Again, the hydroprocessing may be hydrotreating, hydrocracking, or pygas treating, or any combination thereof. The reactor comprises a hydrotreating reactor or hydrotreater, a hydrocracking reactor or hydrocracker, or a pygas reactor or pygas treater, or any combination thereof.

The ranges and limitations provided in the instant specification and claims are those which are believed to particularly point out and distinctly claim the instant invention. It is, however, understood that other ranges and limitations that perform substantially the same function in substantially the same way to obtain the same or substantially the same result are intended to be within the scope of the instant invention as defined by the instant specification and claims.

The techniques may be described by the following examples which are provided for illustrative purposes and are not to be construed as limiting the invention. Table 1 below tabulates exemplary data for some particular examples.

TABLE 1
Examples

| No. | Catalyst | Description | Activity |
|---|---|---|---|
| 1 | Regen CoMo | In-situ sulfided oxide catalyst | 100% |
| 2 | Regen CoMo | actiCAT presulfurized 100% olefin | 97% |
| 3 | Regen CoMo | actiCAT presulfurized100% olefin | 99% |
| 4 | Regen CoMo | Modified actiCAT presulfurized 50% | 109% |
| | | olefin, 50% soybean oil | |
| 5 | Fresh NiMo | In-situ sulfide oxide catalyst | 100% |
| 6 | Fresh NiMo | actiCAT presulfurized 100% olefin | 102% |
| 7 | Fresh NiMo | actiCAT presulfurized 100% olefin | 113% |
| 8 | Fresh NiMo | Modified actiCAT presulfurized 50% | 121% |
| | | olefin, 50% soybean oil | |

The “Regen CoMo” catalyst of Examples 1-4 is a regenerated commercial cobalt/molybdenum hydroprocessing catalyst. This CoMo-type catalyst was regenerated in the laboratory. The “Fresh NiMo” catalyst of Examples 5-8 is a fresh commercial nickel/molybdenum hydroprocessing catalyst. This NiMo-type catalyst is fresh catalyst.

Examples 1 and 5 are used as a reference for the Regen CoMo catalyst and Fresh NiMo catalyst, respectively, and are in-situ sulfided catalyst with the hydrocarbon feedstock in the reactor. In Examples 2 and 6, a first protocol was employed in which the hydroprocessing reactor was started-up and first ran for 3 days with straight run gas oil (SRGO) as the hydrocarbon feedstock, and the reactor then switched to 30/70 weight percent blend of LCO/SRGO as the hydrocarbon feedstock. In Examples 3, 4, 7, and 8, a second protocol was employed in which the reactor was started-up with the 30/70 weight percent blend of LCO/SRGO as the hydrocarbon feedstock.

The standard presulfurization process (Examples 2, 3, 6, 7) involves addition of sulfur and olefin followed by heat treatment at 230° C. The modified presulfurization process (Examples 4, 8) is the same as the standard presulfurization process except that 50% olefin and 50% soybean oil are added instead of 100% olefin. The olefin used is C2024 alpha olefin.

A relative percentage of activity of the catalyst is given in the last column of Table 1. The activity of in-situ sulfided catalysts (Examples 1 and 5) as reference catalyst is designated as a respective 100% activity. The percent activity of Examples 2-4 is relative to the 100% activity of Example 1. The percent activity of Examples 6-8 is relative to the 100% activity of Example 5. As can be seen in Table 1 above, the greatest catalyst activity compared to the reference catalysts is found with the presulfurized catalyst of Examples 4 and 8 which were prepared with the addition of olefin and soybean oil.

TABLE 2
Additional Fresh NiMo Examples

| Example No. | 9 | 10 | 11 | 12 | 13 | 14 | 15 |
|---|---|---|---|---|---|---|---|
| % Olefin | 80 | 60 | 50 | 40 | 20 | 0 | 50 |
| % Soybean Oil | 20 | 40 | 50 | 60 | 80 | 100 | 0 |
| % Canola Oil | 0 | 0 | 0 | 0 | 0 | 0 | 50 |
| Relative Activity | 105% | 106% | 123% | 105% | 106% | 108% | 111% |

In Table 2 above, Examples 9-15 utilized the Fresh NiMo catalyst. The activity reference (100%) for Examples 9-15 is Fresh NiMo catalyst with 100% olefin and subjected to the aforementioned first protocol. Examples 9-15 are Fresh NiMo catalyst subjected to the aforementioned second protocol and having the respective relative amounts listed for olefin, soybean oil, and canola oil. As can be seen, Example 11 (having 50 wt % olefin and 50 wt % soybean oil) gave the greatest relative catalyst activity (123%). Example 11 is a repeat of Example 8, which demonstrates reproducibility

Carbon and sulfur retention analysis was performed before and after activity testing. Analytical data for Examples 1-15 are presented in Table 3 below. The carbon and sulfur retention test determines the amount, in percentage, of sulfur and carbon retained on the catalyst after the presulfurization process. The presulfurized samples are subjected to a hot toluene extraction, washed with petroleum ether, and then air dried. Carbon and sulfur content analysis of the samples before and after the extraction process is used to calculate the percent retention.

TABLE 3
Analytical Data

| | | | Before Activity Test | | | | After Activity Test | | | |
|---|---|---|---|---|---|---|---|---|---|---|
| | | RVA | C | S | C Ret | S Ret | C | S | C Ret | S Ret |
| Example | Protocol | (%) | (wt %) | (wt %) | (%) | (%) | (wt %) | (wt %) | (%) | (%) |
| 1 | 1 | 100 | | | | | 4.96 | 9.93 | 88 | 100 |
| 2 | 1 | 97 | 13.02 | 9.13 | 66 | 93 | 3.95 | 10.17 | 89 | 100 |
| 3 | 2 | 99 | 13.02 | 9.13 | 66 | 93 | 4.1 | 10.55 | 78 | 97 |
| 4 | 2 | 109 | 11.97 | 10.42 | 90 | 84 | 4.62 | 9.86 | 75 | 100 |
| 5 | 1 | 100 | | | | | 3.72 | 8.9 | 84 | 99 |
| 6 | 1 | 102 | 11.66 | 8.82 | 78 | 91 | 3.68 | 7.75 | 66 | 100 |
| 7 | 2 | 113 | 11.66 | 8.82 | 78 | 91 | 4.01 | 7.84 | 58 | 100 |
| 8 | 2 | 121 | 12.18 | 9.19 | 100 | 95 | 4.52 | 9.5 | 84 | 100 |
| 9 | 2 | 105 | 14.03 | 9.19 | 74 | 94 | 8.75 | 7.46 | 29 | 100 |
| 10 | 2 | 106 | 13.17 | 9.81 | 80 | 92 | 8.44 | 7.51 | 30 | 100 |
| 11 | 2 | 125 | 14.39 | 8.66 | 88.4 | 94.9 | 3.29 | 8.82 | 74.4 | 100 |
| 12 | 2 | 105 | 12.79 | 9.95 | 92 | 94 | 3.62 | 8.67 | 70 | 100 |
| 13 | 2 | 106 | 11.69 | 9.27 | 100 | 100 | 3.87 | 9.62 | 64 | 97 |

| | | | | | | |
|---|---|---|---|---|---|---|
| 14 | 2 | 108 | 12.21 | 10.23 | 95 | 92 |
| 15 | 2 | 111 | 12.98 | 8.63 | 89 | 100 |

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed is:

1. A method of presulfurizing a catalyst, comprising:
contacting a catalyst with sulfur, an olefin, and a triglyceride to form a mixture; and
heating the mixture to give a presulfurized catalyst.

2. The method of claim 1, wherein the contacting comprises:
contacting the catalyst with the sulfur to give an initial mixture comprising a sulfur-incorporated catalyst; and
contacting the initial mixture comprising the sulfur-incorporated catalyst with the olefin and the triglyceride to form the mixture.

3. The method of claim 2, wherein the heating comprises heating the initial mixture and heating the mixture.

4. The method of claim 1, wherein the contacting comprises:
contacting the catalyst with the sulfur to give a sulfur-incorporated catalyst; and
contacting the sulfur-incorporated catalyst with the olefin and the triglyceride.

5. The method of claim 4, wherein the heating comprises:
heating the contacting of the catalyst with the sulfur to give the sulfur-incorporated catalyst; and
heating the contacting of the sulfur-incorporated catalyst with the olefin and the triglyceride to give the presulfurized catalyst.

6. The method of claim 1, wherein the triglyceride comprises soybean oil, and the sulfur comprises elemental sulfur or a sulfur compound, or both, and wherein the heating comprises heating the mixture in a substantially inert environment to at least 180° C.

7. The method of claim 1, wherein the heating comprises maintaining the mixture at a temperature of at least 150° C. for a time in the range of about 0.1 hour to 10 hours, and wherein the heating facilitates formation of a carbonaceous barrier external on the presulfurized catalyst and within catalyst pores of the presulfurized catalyst.

8. The method of claim 1, wherein the catalyst comprises a metal oxide catalyst having one or more oxides of metals from Group VIB and Group VII of Periodic Table of Elements, and wherein the olefin comprises olefins having carbon numbers in a range of 6 to 60, and wherein the contacting and the heating give a carbonaceous structure on the presulfurized catalyst.

9. A catalyst composition comprising:
a presulfurized catalyst formed by:
contacting a sulfidable catalyst with sulfur, an olefin, and a triglyceride to form a mixture; and
heating the mixture.

10. The catalyst composition of claim 9, wherein the presulfurized catalyst comprises a presulfurized metal oxide catalyst having one or more oxides of metals from Group VIB and Group VII of Periodic Table of Elements, and wherein the presulfurized catalyst comprises a carbonaceous material.

11. The catalyst composition of claim 9, wherein the sulfidable catalyst comprises a sulfidable metal oxide catalyst having one or more oxides of metals from Group VIB and Group VII of the Periodic Table of Elements.

12. The catalyst composition of claim 9, wherein the olefin comprises olefins having carbon numbers in the range of 6 to 60, wherein the triglyceride comprises soybean oil, and wherein the presulfurized catalyst comprises a carbonaceous barrier formed via the contacting and heating.

13. The catalyst composition of claim 9, wherein the heating comprises heating the mixture to at least 180° C.

14. The catalyst composition of claim 9, wherein the heating comprises maintaining the mixture at a temperature of at least 150° C. for a time in a range of about 0.1 hour to 10 hours.

15. The catalyst composition of claim 9, wherein the contacting comprises:
contacting the sulfidable catalyst with the sulfur to give an initial mixture comprising a sulfur-incorporated catalyst; and
contacting the initial mixture comprising the sulfur-incorporated catalyst with the olefin and the triglyceride to form the mixture.

16. The catalyst composition of claim 15, wherein the heating comprises heating the initial mixture and heating the mixture.

17. A method of hydroprocessing, comprising:
contacting hydrogen, a presulfurized catalyst, and a hydrocarbon feed in a reactor, wherein the presulfurized catalyst is formed by heating a mixture of a sulfidable catalyst, sulfur, an olefin, and a triglyceride;
converting the presulfurized catalyst to a sulfided catalyst in the reactor; and
catalyzing, via the sulfided catalyst, hydroprocessing of the hydrocarbon feed in the reactor.

18. The method of claim 17, wherein the triglyceride comprises soybean oil, and wherein the presulfurized catalyst comprises a metal oxide catalyst having one or more oxides of metals from Group VIB and Group VII of the Periodic Table of Elements, and wherein the presulfurized catalyst comprises a carbonaceous barrier.

19. The method of claim 17, wherein the presulfurized catalyst comprises a carbonaceous barrier formed via the heating of the mixture of the sulfidable catalyst, the sulfur, the olefin, and the triglyceride, and wherein the hydroprocessing comprises hydrotreating, hydrocracking, or pygas treating, or any combination thereof.

20. The method of claim 17, wherein the reactor comprises a hydrotreater, a hydrocracker, or a pygas treater, or any combination thereof.
